(19) United States
(12) Patent Application Publication
(10) Pub. No.: US 2017/0180671 A1
(43) Pub. Date: Jun. 22, 2017

(54) Method for displaying operation trajectory , an electronic device and a non-transitory computer-readable storage medium

(71) Applicants: LE HOLDINGS (BEIJING) CO., LTD., Beijing (CN); LE SHI ZHI XIN ELECTRONIC TECHNOLOGY (TIANJIN) LIMITED, Beijin (CN)

(72) Inventor: Hongbo MA, Beijing (CN)

(21) Appl. No.: 15/242,036

(22) Filed: Aug. 19, 2016

Related U.S. Application Data
(63) Continuation of application No. PCT/CN2016/088784, filed on Jul. 6, 2016.

(30) Foreign Application Priority Data
Dec. 18, 2015 (CN) 2015109695570

(51) Int. Cl. H04N 5/44; H04N 5/445; G06F 3/0488

(52) U.S. Cl. CPC H04N 5/4403; G06F 3/04883; H04N 5/44504; H04N 2005/443

(57) ABSTRACT

Disclosed are a method for displaying an operation trajectory, an electronic device and a non-transitory computer-readable storage medium. The method for displaying an operation trajectory includes: step 1, a display terminal receiving the user operation trajectory data collected by a remote controller, generating layer data which contains the operation trajectory according to the trajectory data, and inserting the layer data into original picture data; and step 2, displaying a picture generated by the original picture data and the data layer to display an operation trajectory image.

### CROSS REFERENCE TO RELATED APPLICATIONS

This application is a continuation of International Application No. PCT/CN2016/088784, filed on Jul. 6, 2016, which is based upon and claims priority to Chinese Patent Application NO. 201510969557.0, titled “method for displaying operation trajectory of remote controller, remote controller and display terminal”, filed with the State Intellectual Property Office of PRC on Dec. 18, 2015, the entire contents of which are incorporated herein by reference.

### TECHNICAL FIELD

The present invention is related to a technical field of electronic products, and in particular, to a method for displaying an operation trajectory, an electronic device and a non-transitory computer-readable storage medium.

### BACKGROUND

With gradual development of electronic products, features of display devices such as television are increasingly diverse. Remote controllers which match with some smart televisions are provided with functions of touch and slide controls. For example, there is provided a touch pad on the remote controller of the television, and a user may make a slide action on the touch pad to give an indication to the television.

During implementation of the present invention, however, the inventors found that a success rate of usage of the functions of performing remote control on the television by slide actions and swinging gesture is not high, which results in inconvenience for the user to use. For example, the user wants to indicate the television to page menu by sliding from left to right on the touch panel, but the television makes no response due to the operation indication is not received. For these reasons, the user experience of this type of remote control mode is not ideal.

Therefore, it is necessary to improve a technology of a remote control by slide and gesture. allowing the user to obtain a good and convenient experience in use.

### SUMMARY

In view of aforesaid problems, embodiments of the disclosure are put forward to provide a method for displaying an operation trajectory, an electronic device and a non-transitory computer-readable storage medium thereof to overcome aforesaid problems or at least partly solve aforesaid problems.

According to one aspect of the disclosure, there is provided a method for displaying an operation trajectory which includes:

step 1, a display terminal receiving a user operation trajectory data collected by a remote controller, generating layer data which contains the operation trajectory according to the trajectory data, and inserting the layer data into original picture data; and

step 2, displaying a picture generated by the original picture data and the data layer to display an operation trajectory image.

According to another aspect of the disclosure, there is provided a non-transitory computer-readable storage medium which stores executable instructions. The executable instructions are set for:

a display terminal receiving a user operation trajectory data collected by a remote controller, generating layer data which contains the operation trajectory according to the trajectory data, and inserting the layer data into original picture data; and

displaying a picture generated by the original picture data and the data layer to display an operation trajectory image.

According to a further aspect of the disclosure, there is provided an electronic device which includes:

at least one processor, and

a storage which is communicated by at least one processor, wherein,

The storage stores executable instruction by one processor. The instruction is executed by the at least one processor, and enable the at least one processor to perform:

step 1, a display terminal receiving a user operation trajectory data collected by a remote controller, generating layer data which contains the operation trajectory according to the trajectory data, and inserting the layer data into original picture data; and step 2, displaying a picture generated by the original picture data and the data layer to display an operation trajectory image.

The inventors of the present invention found that, in the prior art, those skilled in the art does not realize a main reason of usage inconvenient of remote control operations such as slide and gesture reported by the user, and technical staff try to solve the problem by improving a sensing mode and improving the determination sensitivity, but ignoring a problem that user operations are irregular. According to the present invention, a trajectory of the slide operation is displayed on the display terminal, so that the user can correct operational actions on its own, thereby improving the usage convenience level of slide, gesture and other operations, and improving the user experience. Therefore, a technical task to be achieved or a technical problem to be solved for the present invention is never thought or did not be expected by those skilled in the art, and therefore the present invention is a new technical solution.

Above description is only a summary of the technical scheme of the disclosure. In order to know the technical means of the disclosure more clearly so that it can be put into effect according to the content of the description, and to make aforesaid and other purpose, features and advantages of the disclosure clearer, embodiments of the disclosure are listed below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for displaying an operation trajectory of a remote controller according to an embodiment of the present invention;

FIG. 2 is a structure block diagram of a remote controller according a specific embodiment of the present invention;

FIG. 3 is a structure block diagram of a display terminal according a specific embodiment of the present invention;

FIG. 4 schematically shows hardware structure of an electronic device for displaying the operation trajectory according to an embodiment of the disclosure.

### DETAILED DESCRIPTION

Exemplary embodiments of the disclosure are described in further detail with reference to the drawings below. Although exemplary embodiments of the present disclosure are shown in the drawings, it should be understood that the present disclosure can be implemented in various forms and should not be limited by the embodiments set forth herein. Rather, these embodiments are provided for a more thorough understanding of the present disclosure, and to convey the scope of the present disclosure to those skilled in the art completely.

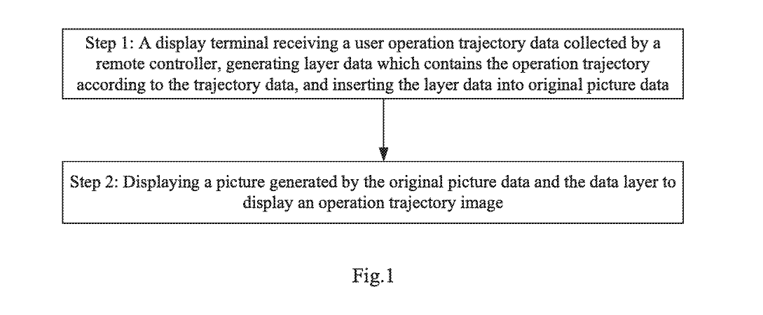

The present invention provides a method for displaying an operation trajectory, as shown in FIG. 1, including step 1, a display terminal receiving the user operation trajectory data collected by a remote controller, generating layer data which contains the operation trajectory according to the trajectory data, and inserting the layer data into original picture data; and step 2, displaying a picture generated by the original picture data and the data layer to display an operation trajectory image.

The remote controller having a function of indication by means of gesture and slide operation is usually provided with a sensor which may sense the above-described actions. The remote controller first collects a control action made by a user, forming an operation trajectory. The trajectory data is then generated according to the operation trajectory, and in the trajectory data, a trajectory of slide and gesture actions made by the user is recorded, which may be used to send to a display terminal such as television. In the step 1, the display terminal may receive the trajectory data send from the remote controller, and restore the trajectory of the operations and control actions made by the user according to the trajectory data. The display terminal may separately form a layer data according to the trajectory data, in which trajectory characteristics for user operation are recorded. Thereafter, the layer data is inserted into original picture data as a part of the display picture. In the step 2, a television or a display may generate a picture according to the original picture data and the layer data, and broadcast the picture on the display. As such, the trajectory of slide actions and operations on the remote controller made by the user is displayed on the display terminal.

The inventors of the present invention found that, for such operation functions for the remote control by using touch slide or gesture, in many cases the problem that the success rate of user operations described in the background art is not high and the user inconvenience is not because of the problem of remote controller sensing or television response, but often because the television cannot recognize the indication due to the user's irregular operation indications. For example, the user wants to slide from left to right in order to achieve paging, however, the action made actually by the user might be an action of sliding from lower left to upper right and will form an operation indication of an oblique line due to the factors such as postures when holding the remote controller and activity habits of fingers, and thus the television does not recognize the user's indications. According to the present invention, the slide operation made by the user is displayed on the display terminal, thereby allowing the user to visually watch the trajectory of the operations made by himself. If the above misuse occurs, the user is able to clearly recognize the misuse, adjusting his action and making a standard operation instruction. According to the present invention, the operation trajectory is displayed on the display terminal, improving the success rate of operation indications issued by the user, and further improving the convenience level and the user experience.

The methods for collecting the operation trajectory by a remote controller may be implemented in various forms. In one embodiment of the present invention, optionally, the user's touch points may be collected by the remote controller at a fixed frequency, and then these touch points be chronologically connected together to form an operation trajectory. For the present invention, it is not limited to have to use such collection mode to collect the operation trajectory, and this collection mode is adapted to devices such as touchpad. In other embodiments of the present invention, other ways to collect trajectory of user's slide action and gesture operation such as an infrared sensor may also be employed by those skilled in the art.

Preferably, in the steps 1, the trajectory data may be generated, send and received via the 2.4 G transmission protocol. With a strong anti-interference ability and characteristics of long distance transmission, low loss, and high transmission rate, the 2.4 G transmission protocol is adapted to transmit remote control signals of electronic devices such as television and home game console. In the present embodiment, the trajectory data in line with the 2.4 G transmission protocol may be generated according to the operation trajectory and send to the display terminal. In the step 1, the trajectory data is received by the display terminal via the 2.4 G transmission protocol. For the present invention, it is not limited to only use the 2.4 G transmission protocol to transmit signals, those skilled in the art may choose to use other wireless signal transmission protocol according to the actual situation.

In particular, when an operation trajectory image is displayed on a display terminal, it may affect the user to view original picture normally. Therefore, preferably, in the step 2, only a portion of the space of the original picture may be occupied by the operation trajectory image, for example, by forming the operation trajectory image on a upper right portion of the original picture, to avoid a major portion of the original picture is obscured by the operation trajectory image. In other embodiments of the present invention, those skilled in the art may also employ a method of making sides of a portion of the display terminal screen empty for displaying the operation trajectory image by zooming out the original picture appropriately, to prevent the trajectory image from obscuring the original picture. Furthermore, in the step 2, the operation trajectory image may be displayed on the original picture in a translucent form, to prevent the operation trajectory image from completely obscuring the original picture. More preferably, those skilled in the art may use the technique of displaying the operation trajectory image in a translucent form in combination with the technique of making the operation trajectory image occupy only a part of the space described above, which can obtain a better display effect.

With the method for displaying an operation trajectory according to an embodiment of the present invention, a user's operation trajectory is collected, and trajectory data is generated. Layer data containing the operation trajectory is generated according to the trajectory data, and is inserted into the original picture data. By displaying a picture generated by the original picture data and the layer data on a display terminal, the user can easily correct operate action on its own according to the picture, improving use convenience level of slide, gesture and other operations and improving the user experience.

On the other hand, the present invention also provides a remote controller and a display terminal which may implement the above method.

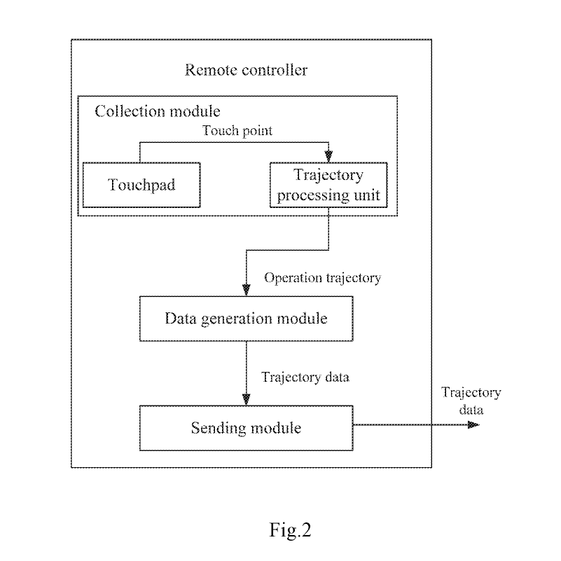

The remote controller as shown in FIG. 2 may include a collection module, a data generation module and a sending module. The collection module may be configured to collect an operate trajectory of user's action indications such as slide and gesture. The data generation module is configured to generate trajectory data according to the operation trajectory, and characteristics of the operation trajectory are recorded in the trajectory data. The sending module is configured to send the trajectory data.

Optionally, for example, in one embodiment of the present invention, the collection module may include a touch pad and a trajectory processing unit. The touchpad typically senses of a user's touch according to changes in capacity and resistance, and may be arranged to sense touch points of the user in a fixed frequency. The trajectory processing unit then may make the touch points sensed by the touchpad connected chronologically into an operation trajectory. For the present invention, it is not limited to have to collect the operation trajectory in this way, and in other embodiments of the present invention, a continuously sensing device may also be employed to collect the operation trajectory, which may be selected by those skilled in the art according to actual needs.

Preferably, the data generation module may generate the trajectory data in line with the 2.4 G transmission protocol according to the operation trajectory, and then the sending module may send the trajectory data via the 2.4 G transmission protocol.

With the remote controller according to an embodiment of the present invention, an operation trajectory may be collected, and trajectory data may be generated and sent. By collecting the trajectory data, operational actions of the user are further obtained. By sending the relevant trajectory data to for example a display terminal, and displaying the corresponding operational actions of the user on the display terminal, the user may easily correct the operational actions on its own, improving usage convenience level of slide and gesture and other operations and improving the user experience.

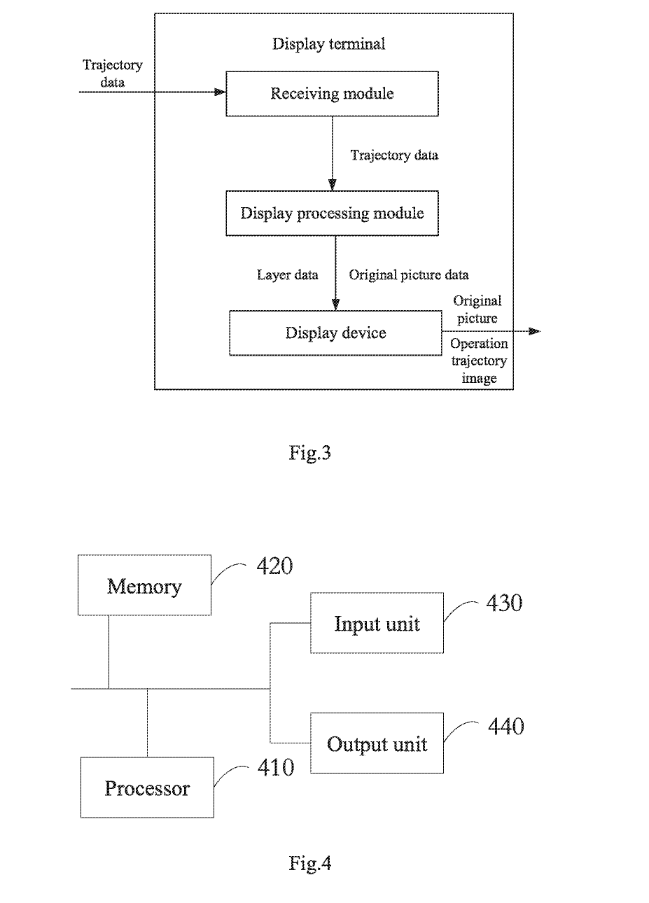

The display terminal as shown in FIG. 3 may be a display or a television, and may include a receiving module, a display processing module and a display device. The receiving module is configured to receive the trajectory data, and then the display processing module may generate layer data containing the operation trajectory according to the trajectory data. The display processing module is also configured typically to process data of a picture required to be broadcasted originally, that is, original picture data. Therefore, the display processing module may insert the layer data into the original picture data. Furthermore, the display device then may generate a picture according to the original picture data and the layer data, and the operation trajectory image is displayed in the picture. The display device may be a CRT device, a liquid crystal display device and other devices, which are not limited to the present invention.

Preferably, the receiving module may also receive the trajectory data via the 2.4 G transmission protocol, to achieve the function of displaying steadily the operation trajectory image by using characteristics of high efficient and reliability of the 2.4 G transmission protocol.

With the display terminal according to an embodiment of the present invention, a trajectory of the slide operation is displayed on the display terminal, so that the user may correct operational actions on its own, thus improving the usage convenience level of slide, gesture and other operations, and improving the user experience.

FIG. 4 is schematically shows hardware structure of an electronic device for displaying the operation trajectory according to an embodiment of the disclosure. As shown in FIG. 4, the device includes: one or more processors 410 and memory 420. One processor 410 is shown in FIG. 4 for an example.

The device for displaying the operation trajectory can also include: input unit 430 and output unit 440.

Processor 410, memory 420, input unit 430 and output unit 440 can be connected by BUS or other methods, and BUS connecting is showed in FIG. 4 for an example.

Memory 420 can be used for storing non-transitory software program, non-transitory computer executable program and modules as a non-transitory computer-readable storage medium, such as corresponding program instructions/modules for the methods for displaying the operation trajectory mentioned by embodiments of the present disclosure (such as shown in FIG. 2, collection module, data generation module and sending module). Processor 410 performs kinds of functions and data processing of the electronic device by executing non-transitory software program, instructions and modules which are stored in memory 420, thereby realizes the methods for displaying the operation trajectory mentioned by embodiments of the disclosure.

Memory 420 can include program storage area and data storage area, thereby the operating system and applications required by at least one function can be stored in program storage area and data created by using the device for displaying the operation trajectory can be stored in data storage area. Furthermore, memory 420 can include high speed Random-access memory (RAM) or non-volatile memory such as magnetic disk storage device, flash memory device or other non-volatile solid state storage devices. In some embodiments, memory 420 can include long-distance setup memories relative to processor 410, which can communicate with the device for displaying the operation trajectory by networks. The examples of said networks are including but not limited to Internet, Intranet, LAN, mobile Internet and their combinations.

Input unit 430 can be used to receive inputted number, character information and key signals causing user configures and function controls of the device for adjusting the display brightness of a screen. Output unit 440 can include a display screen or a display device.

The said module or modules are stored in memory 420 and perform the methods for adjusting the display brightness of a screen when executed by one or more processors 410.

The said device can reach the corresponding advantages by including the function modules or performing the methods provided by embodiments of the present invention. Those methods can be referenced for technical details which may not be completely described in this embodiment.

Electronic devices in embodiments of the present invention can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure

1-12. (canceled)

13. A method for displaying an operation trajectory, which includes:
step 1, a display terminal receiving a user operation trajectory data collected by a remote controller, generating layer data which contains the operation trajectory according to the trajectory data, and inserting the layer data into original picture data; and
step 2, displaying a picture generated by the original picture data and the data layer to display an operation trajectory image

14. The method for displaying an operation trajectory according to claim 13, which further includes: the remote controller collecting touch points at a fixed frequency, and connecting the touch points chronologically to form the operation trajectory.

15. The method for displaying an operation trajectory according to claim 13, wherein, in the step 1, the trajectory data is received by the display terminal via the 2.4 G transmission protocol.

16. The method for displaying an operation trajectory according to claim 13, wherein, in the step 2, a part of the space of an original picture is occupied by the operation trajectory image.

17. The method for displaying an operation trajectory according to claim 13, wherein, in the step 2, the operation trajectory image is displayed on the original picture in a translucent form.

18. A non-transitory computer-readable storage medium which stores executable instructions. The executable instructions are set for:
Step 1, a display terminal receiving a user operation trajectory data collected by a remote controller, generating layer data which contains the operation trajectory according to the trajectory data, and inserting the layer data into original picture data; and
Step 2, displaying a picture generated by the original picture data and the data layer to display an operation trajectory image.

19. The non-transitory computer-readable storage medium according to claim 18, the executable instructions are further set for:
the remote controller collecting touch points at a fixed frequency, and connecting the touch points chronologically to form the operation trajectory.

20. The non-transitory computer-readable storage medium according to claim 18, wherein,
in the step 1, the trajectory data is received by the display terminal via the 2.4 G transmission protocol.

21. The non-transitory computer-readable storage medium according to claim 18, wherein,
in the step 2, a part of the space of an original picture is occupied by the operation trajectory image.

22. The non-transitory computer-readable storage medium according to claim 18, wherein,
in the step 2, the operation trajectory image is displayed on the original picture in a translucent form.

23. An electronic device, which includes:
at least one processor, and
a storage which is communicated by at least one processor, wherein,
The storage stores executable instruction by one processor. The instruction is executed by the at least one processor, and enables the at least one processor to perform:
step 1, a display terminal receiving a user operation trajectory data collected by a remote controller, generating layer data which contains the operation trajectory according to the trajectory data, and inserting the layer data into original picture data; and
step 2, displaying a picture generated by the original picture data and the data layer to display an operation trajectory image.

24. The electronic device according to claim 23, the at least one processor performs:
the remote controller collecting touch points at a fixed frequency, and connecting the touch points chronologically to form the operation trajectory.

25. The electronic device according to claim 23, wherein,
in the step 1, the trajectory data is received by the display terminal via the 2.4 G transmission protocol.

26. The electronic device according to claim 23, wherein,
in the step 2, a part of the space of an original picture is occupied by the operation trajectory image.

27. The electronic device according to claim 23, wherein,
in the step 2, the operation trajectory image is displayed on the original picture in a translucent form.
